(19) United States
(12) Patent Application Publication
(10) Pub. No.: US 2010/0222491 A1
(43) Pub. Date: Sep. 2, 2010

(54) AQUEOUS FLUOROPOLYMER DISPERSION

(75) Inventors: Chie Sawauchi, Settsu-shi (JP); Nobuhiko Tsuda, Settsu-shi (JP); Toshirou Miura, Settsu-shi (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD., Osaka-Shi, Osaka (JP)

(21) Appl. No.: 12/095,653

(22) PCT Filed: Dec. 28, 2006
(86) PCT No.: PCT/JP2006/326247

§ 371 Date: May 30, 2008

(30) Foreign Application Priority Data
Dec. 28, 2005 (JP) 2005-380421

(51) Int. Cl. C09D 127/18; C09D 153/00

(52) U.S. Cl. 524/505; 524/546; 524/502

(57) ABSTRACT

The present invention has an object to provide an aqueous fluoropolymer dispersion which is excellently prevented from foaming without significant impairment in viscosity and in mechanical stability. The present invention is related to an aqueous fluoropolymer dispersion comprising a particle of fluoropolymer as dispersed in an aqueous medium in the presence of a specific nonionic surfactant, wherein the specific nonionic surfactant comprises a compound having an average total hydrophilic group content of 45 to 90% by mass, each hydrocarbon group in the compound constituting the specific nonionic surfactant is only a hydrocarbon group of 1 to 5 consecutively neighboring carbon atoms, and the fluorinated surfactant in the aqueous fluoropolymer dispersion amounts to 500 ppm or less of the solid matter of the fluoropolymer.

### TECHNICAL FIELD

The present invention relates to an aqueous fluoropolymer dispersion.

### BACKGROUND ART

Aqueous fluoropolymer dispersions, when applied in the manner of coating or impregnation, for instance, can form films, coating films and the like excellent in such characteristics as chemical stability, nonstickiness and weather resistance and therefore are widely used in the fields of cooking utensils, pipe linings and impregnated glass cloth membranes, among others.

Aqueous fluoropolymer dispersions are generally produced by polymerization in the presence of a fluorinated surfactant and it is preferred that the fluorinated surfactant content be as low as possible from the viewpoint of characteristics of films and so forth.

Several methods are known for reducing the fluorinated surfactant content in aqueous fluoropolymer dispersions, for example the phase separation, ion exchange resin, membrane treatment, and electrophoretic methods (cf. e.g. Patent Documents 1-4).

However, aqueous fluoropolymer dispersions reduced in fluorinated surfactant content have problems: namely, they are high in viscosity and poor in storage stability and mechanical stability.

In Patent Document 3, for instance, there is proposed a method of concentrating fluoropolymers which comprises passing a fluoropolymer dispersion, with a specific nonionic, anionic or cationic surfactant added for the purpose of stabilization, through a semipermeable ultrafiltration membrane. According to the examples in this document, however, the concentrated dispersion obtained still contains ammonium perfluorooctanoate [PFOA] in a concentration amounting to 900 ppm of the fluoropolymer; the document does not refer to the problem which may arise when the PFOA concentration is further reduced.

Regarding aqueous fluoropolymer dispersions, a method of reducing the fluorinated surfactant content has been proposed which comprises effecting fluoropolymer concentration by ultrafiltration in the presence of a nonfluorinated nonionic surfactant or a mixture of such surfactant and a nonfluorinated anionic surfactant selected so as to reduce the fluorinated surfactant concentration and provide a specific viscosity characteristic (VTT) while adding nonfluorinated anionic surfactant before or after the concentration operation to adjust the VTT (cf. e.g. Patent Document 5).

An aqueous fluoropolymer dispersion improved with respect to the problems of viscosity increase and stability decrease has been proposed which contains a specific nonfluorinated anionic surfactant or fluorinated anionic surfactant (cf. e.g. Patent Document 6). However, the nonfluorinated anionic surfactant that can be used in this method is limited to one having a molecular weight of 1000 or higher.

In any of the documents cited above, there is no description about the foaming of aqueous fluoropolymer dispersions.

### Patent Document 1: International Laid-open Publication 2004/050719

### Patent Document 2: Japanese Kohyo Publication 2002-532583

Patent Document 3: Japanese Kokai Publication sho-55-120630

### Patent Document 4: British Patent No. 642025

### Patent Document 5: United States Patent Application Publication 2004/171736

### Patent Document 6: United States Patent Application Publication 2004/186219

### DISCLOSURE OF INVENTION

### Problems which the Invention is to Solve

In view of the above-discussed state of the art, it is an object of the present invention to provide an aqueous fluoropolymer dispersion which is excellently prevented from foaming without significant impairment in viscosity and in mechanical stability.

### Means for Solving the Problems

The present invention is related to an aqueous fluoropolymer dispersion comprising a particle of fluoropolymer as dispersed in an aqueous medium in the presence of a specific nonionic surfactant, wherein the specific nonionic surfactant comprises a compound having an average total hydrophilic group content of 45 to 90% by mass, each hydrocarbon group in the compound constituting the specific nonionic surfactant is only a hydrocarbon group of 1 to 5 consecutively neighboring carbon atoms, and the fluorinated surfactant in the aqueous fluoropolymer dispersion amounts to 500 ppm or less of the solid matter of the fluoropolymer. Hereinafter, this aqueous fluoropolymer dispersion is referred to as “aqueous fluoropolymer dispersion A”.

The present invention is related to an aqueous fluoropolymer dispersion comprising a particle of fluoropolymer as dispersed in an aqueous medium in the presence of a specific nonionic surfactant, wherein the specific nonionic surfactant comprises a compound having a unit —C₃H₆O— and/or —OC₃H₆— in the total mass of 500 to 5000 g per mole of the compound constituting the specific nonionic surfactant, each hydrocarbon group in the compound constituting the specific nonionic surfactant is only a hydrocarbon group of 1 to 5 consecutively neighboring carbon atoms, and the fluorinated surfactant in the aqueous fluoropolymer dispersion amounts to 500 ppm or less of the solid matter of fluoropolymer. Hereinafter, this aqueous fluoropolymer dispersion is referred to as “aqueous fluoropolymer dispersion B”.

In the following, the present invention is described in detail. Hereinafter, the above-mentioned aqueous fluoropolymer dispersion A and the above-mentioned aqueous fluoropolymer dispersion B are sometimes collectively referred to as “aqueous fluoropolymer dispersion of the present invention”.

The aqueous fluoropolymer dispersion of the present invention comprises a particle of fluoropolymer as dispersed in an aqueous medium in the presence of a specific nonionic surfactant.

In the practice of the present invention, the fluoropolymer is a polymer having fluorine atoms respectively bound to carbon atoms.

The fluoropolymer is not particularly restricted but includes polytetrafluoroethylene [PTFE], modified PTFE, tetrafluoroethylene [TFE]/hexafluoropropylene [HFP] copolymers [FEPs], TFE/perfluoro(alkyl vinyl ether) [PAVE] copolymers [PFAs], ethylene/TFE copolymers [ETFEs], poly(vinylidene fluoride) [PVDF] and polychlorotrifluoroethylene [PCTFE], among others.
The term “modified PTFE” as used herein means a non-melt-processable fluoropolymer obtained by polymerizing TFE and a very small proportion monomer. As the very small proportion monomer, there may be mentioned, for example, fluoroolefins such as HFP and chlorotrifluoroethylene [CTFE], fluoro(alkyl vinyl ether) species whose alkyl moiety has 1 to 5 carbon atoms, in particular 1 to 3 carbon atoms; fluorodioxoles; perfluoroalkylethylenes; and ω-hydroperfluoroolefins.
Perfluoropolymers are preferred as the above fluoropolymer, and PTFE and modified PTFE are preferred among others.

The particles of fluoropolymer generally have an average primary particle diameter of 50 to 500 nm, preferably 100 to 350 nm.

The average primary particle diameter mentioned above is determined in the following manner. A working curve is constructed which shows the relation between the transmittance of incident light rays having a wavelength of 550 nm per unit length of an aqueous dispersion adjusted to a fluoropolymer concentration of 0.22% by mass and the average primary particle diameter determined by particle diameter measurements in a certain specific direction on a transmission electron photomicrograph, and the average primary particle diameter of a sample is determined, using the working curve, from the transmittance as measured in the above manner.

The aqueous fluoropolymer dispersion of the present invention preferably contains the above-mentioned fluoropolymer in an amount of 30 to 80% by mass thereof.

A more preferred lower limit of the fluoropolymer amount is 35% by mass, and a preferred upper limit thereof is 75% by mass. The content of the fluoropolymer, so referred to herein, is determined by weighing about 1 g (X) of the sample in an aluminum cup with a diameter of 5 cm, drying the sample at 100° C. for 1 hour and then further drying at 300° C. for 1 hour to give a heating residue (Z) and making a calculation as follows: P=Z/X×100(%).

The aqueous medium in the aqueous fluoropolymer dispersion of the present invention is not particularly restricted but may be any water-containing liquid. Thus, it may contain, in addition to water, a non-fluorinated organic solvent and/or a fluorinated organic solvent such as an alcohol, ether, ketone or paraffin wax.

The aqueous fluoropolymer dispersion of the present invention contains a specific nonionic surfactant.

The aqueous fluoropolymer dispersion may be one containing on a kind of specific nonionic surfactants or may be one containing two or more kinds of specific nonionic surfactants. The aqueous fluoropolymer dispersion A and aqueous fluoropolymer dispersion B may be ones respectively containing a specific nonionic surfactant a and a specific nonionic surfactant b, which are to be described later herein. Hereinafter, the specific nonionic surfactants to be used in the practice of the present invention, including the specific nonionic surfactant a and specific nonionic surfactant b, are collectively referred to merely as “specific nonionic surfactant”.

The specific nonionic surfactant, so referred to herein, means one comprising a compound having a hydrophobic group and a hydrophilic group, which are to be described later herein, and showing an emulsifying activity.

In the specific nonionic surfactant, each hydrocarbon group in the compound constituting the specific nonionic surfactant is preferably only a hydrocarbon group of 1 to 5 consecutively neighboring carbon atoms from the viewpoint of presumable environment-friendliness.
More preferred as the hydrocarbon group in the above-mentioned compound is a hydrocarbon group of 2 to 4 consecutively neighboring carbon atoms in view of their being used in food additives. The above-mentioned “number of consecutively neighboring carbon atoms” is the number of carbon atoms neighboring consecutively and constituting a carbon chain free of such a hetero atom as an ether oxygen atom [—O—], namely a carbon chain in which the carbon atoms are linked together without interruption.

The compounds constituting the above-mentioned specific nonionic surfactant generally comprise a compound having a hydrophobic group and a hydrophilic group within the molecule and showing an emulsifying activity.

The specific nonionic surfactant to be present in the aqueous fluoropolymer dispersion A (hereinafter referred to as “specific nonionic surfactant a”) comprises a compound having an average total hydrophilic group content of 45 to 90% by mass. In the specific nonionic surfactant a, a preferred lower limit to the average total hydrophilic group content is 50% by mass, a more preferred lower limit thereto is 55% by mass, and a preferred upper limit thereto is 80% by mass.
Each compound constituting the specific nonionic surfactant a may have, as a hydrophilic group, an ethylene oxide group and/or a hydroxyl group, for instance.

Each compound constituting the specific nonionic surfactant a is not particularly restricted provided that it has the hydrocarbon group mentioned above.

The above-mentioned compound preferably has a repeating structure of —RO— and/or —OR— as the hydrophobic group.
The symbol R represents a hydrocarbon group of 3 to 5 carbon atoms.
The hydrocarbon group R may be straight or branched and, in the case of a hydrocarbon group of 3 carbon atoms, the structure may be —OCH₂CH₂CH₂— or —OCH(CH₃)CH₂—.
In the present specification, the above-mentioned “—RO— and/or —OR-” is hereinafter abbreviated as “—RO—” unless otherwise specified. Similarly, unless otherwise specified, “—C₂H₄O— and/or —OC₂H₄—” is abbreviated as “—C₂H₄O—” or “EO”, and “—C₃H₆O— and/or —OC₃H₆—” as “—C₃H₆O—” or “PO”.

In the repetitions of the above-mentioned —RO—, the R may be straight or branched and may be the same or different with one another.

As the R, there may be mentioned, for example, alkylene groups of 3 to 5 carbon atoms. Among them, —C₃H₆— and —C₄H₈— are preferred, and —C₃H₆— is more preferred.
As for the repetitions of —RO—, the number of repetitions of —RO— is preferably 5 to 85, more preferably 10 to 70, still more preferably 15 to 60.
The above-mentioned compound may has one segment consisting of repetitions of —RO—, or two or more of such segments.

The total mass of the above-mentioned —RO— is preferably 300 to 7000 g per mole of the compound constituting the specific nonionic surfactant.

When the total mass (g) of —RO— is higher than the above range, the hydrophobicity of the specific nonionic surfactant generally becomes high and the solubility in water tends to become low and, when the total mass is lower than the above range, the surface activity may be low.
The above-mentioned total mass of —RO— is the total mass of the segment including the repetitions of —RO—, and a preferred lower limit thereto is 500 g, a more preferred lower limit is 750 g, a preferred upper limit is 6000 g and a more preferred upper limit is 5000 g, per mole of the compound.
In particular, the above-mentioned compound is preferably one in which the above-mentioned —RO— is —C₃H₆O— and the total mass of the —C₃H₆O— is 300 to 7000 g per mole of the compound, more preferably 500 to 5000 g per mole of the compound.

In the aqueous fluoropolymer dispersion A, a fluorinated surfactant concentration amounts to 500 ppm or less of the solid matter of fluoropolymer.

The species and preferred content of the fluorinated surfactant are described later herein.

The specific nonionic surfactant present in the aqueous fluoropolymer dispersion B (hereinafter referred to as “specific nonionic surfactant b”) comprises a compound in which the total mass of the unit —C₃H₆O— is 500 to 5000 g per mole of the compound constituting the specific nonionic surfactant b.

In the compound constituting the specific nonionic surfactant b, a preferred lower limit to the total mass of the unit —C₃H₆O— is 800 g and a more preferred lower limit is 1000 g.

The hydrophilic group in the compound constituting the specific nonionic surfactant b preferably comprises a repeating structure of —C₂H₄O—.

In the above compound, the total content of the unit —C₂H₄O— is preferably 45 to 90% by mass of that compound.
A more preferred lower limit to the total content of the unit —C₂H₄O— is 50% by mass, and a more preferred upper limit thereto is 85% by mass.

The compound constituting the specific nonionic surfactant b may have another hydrophobic group and/or hydrophilic group in addition to the repeating structure of the unit —C₃H₆O— and the hydrophilic group having the unit —C₂H₄O—. As such hydrophobic group, there may be mentioned repetitions of a unit —R′O— (in which R′ represents a hydrocarbon chain of 4 or 5 carbon atoms) and, as the above hydrophilic group, there may be mentioned a hydroxyl group, among others.

In the aqueous fluoropolymer dispersion of the present invention, from the viewpoint of suppressing viscosity increases and foaming, the compound constituting the specific nonionic surfactant preferably has a unit —C₂H₄O— with a content as high as possible within the range mentioned above when it has that unit and, when it has —C₃H₆O—, preferred as the content of that is as high as possible within the range mentioned above. From the viewpoint of suppressing viscosity increases and foaming, the average content of the unit —C₂H₄O— in the above-mentioned compound is preferably 45% or higher by mass, more preferably 50% or higher by mass and, within the above range, it is preferably 90% or lower by mass, more preferably 85% or lower by mass.

From the viewpoint of suppressing viscosity increases and foaming, the total mass of the unit —C₃H₆O— per mole of the above compound is preferably 500 g or more, more preferably 1000 g or more and, within the above range, it is preferably 5000 g or less.
Even when the aqueous fluoropolymer dispersion of the present invention contains only a kind of compounds having the unit —C₂H₄O— as the specific nonionic surfactant, the compound may be any one kind of compounds having the unit —C₂H₄O— within the range mentioned above.
When the aqueous fluoropolymer dispersion of the present invention contains two or more kinds of compounds having the unit —C₂H₄O— as the specific nonionic surfactant, such a specific nonionic surfactant that the contents of the above-mentioned unit —C₂H₄O— may not show multimodality is preferably selected from the viewpoint that the foaming-suppressing and other effects are to be efficiently produced in proportion to the amount of the surfactant used.

As the compound constituting the specific nonionic surfactant, there may be mentioned, for example, ethylene oxide-propylene oxide copolymers.

The compound constituting the specific nonionic surfactant is preferably an ethylene oxide-propylene oxide block copolymer. As the block copolymer, there may be mentioned those represented by the following general formula (1) or (2) given below.

R¹O-(EO)ₙ₁—(PO)ₙ₂-(EO)ₙ₃—R² (1)

R¹O—(PO)ₙ₄-(EO)ₙ₅—(PO)ₙ₆—R² (2)

(In the above formulas, R¹ and R² are the same or different and each represents H or an alkyl group of 1 to 5 carbon atoms, n1 and n3 are the same or different and the sum of the numbers n1 and n3 is an integer of 1 to 200, n2 represents an integer of 5 to 85, n4 and n6 are the same or different and the sum of n4 and n6 is an integer of 10 to 70, and n5 represents an integer of 2 to 200. The alkyl groups represented by R¹ and R² may contain another element such as fluorine substituting for any of hydrogen atoms.)

The above-mentioned R¹ and R² each is preferably H or an alkyl group of 1 to 5 carbon atoms, more preferably H or an alkyl group of 1 to 3 carbon atoms.

In the above formulas, —C₃H₆— in each PO may be straight or branched, as mentioned hereinabove.
In the above formula (1), the sum of n1 and n3 is preferably an integer of 2 to 180, and n2 is preferably an integer of 10 to 70, more preferably an integer of 15 to 60.
In the above formula (2), the sum of n4 and n6 is preferably an integer of 15 to 60, and n5 is preferably an integer of 2 to 150.

The compounds constituting the specific nonionic surfactant preferably have an average molecular weight lower than 15000.

A more preferred upper limit to the above-mentioned average molecular weight is 12000 or below, a still more preferred upper limit thereto is 10000 or below and, within the above range, the average molecular weight may be 500 or higher, preferably 1000 or higher, more preferably 1500 or higher.
When the above-mentioned average molecular weight is higher, the hydrophobicity of the specific nonionic surfactant is generally high and the solubility in water tends to decrease and, when that average molecular weight is lower, the surface activity tends to be insufficient.

The above-mentioned specific nonionic surfactant generally show a cloud point of 20 to 90° C.

A preferred lower limit to the above cloud point is 20° C., and a more preferred upper limit thereto is 80° C., more preferably 70° C.
The cloud point, so referred to herein, is the value determined according to ISO 1065 (Method A) in the following manner. A 15-ml portion of a diluted sample for measurement is placed in a test tube and heated until complete opacification and then gradually cooled with stirring; the temperature at which the whole liquid again becomes transparent is the cloud point.

The specific nonionic surfactant preferably has an HLB value of 1 to 20, more preferably 5 to 19.

The above-mentioned HLB value is the value calculated from Griffin's formula.
A 10% (by mass) aqueous solution of the specific nonionic surfactant preferably shows an electric conductivity of not higher than 2000 mS/cm, more preferably not higher than 1000 mS/cm, still more preferably not higher than 500 mS/cm.
The electric conductivity, so referred to herein, is the value determined at 25° C. using an electric conductivity meter (product of Orion).

In the aqueous fluoropolymer dispersion of the present invention, the specific nonionic surfactant preferably amounts to 0.5 to 15 parts by mass per 100 parts by mass of the fluoropolymer.

A more preferred lower limit to the amount of the specific nonionic surfactant is 1 part by mass and a more preferred upper limit thereto is 10 parts by mass, per 100 parts by mass of the fluoropolymer.
When the aqueous fluoropolymer dispersion contains two or more kinds of specific nonionic surfactants, the above-mentioned specific nonionic surfactant amount indicates the total amount of the respective specific nonionic surfactants.

The aqueous fluoropolymer dispersion of the present invention may contain, as a surfactant, other kinds of surfactants in addition to the above-mentioned specific nonionic surfactant.

The surfactant mentioned above is not particularly restricted but may be, for example, a nonionic surfactant or anionic surfactant known in the art.
Usable as the nonionic surfactant mentioned above are those known in the art, for example ether type nonionic surfactants such as polyoxyethylene alkylphenyl ethers, polyoxyethylene alkyl ethers and polyoxyethylenealkylene alkyl ethers; ester type nonionic surfactants such as sorbitan fatty acid esters, polyoxyethylenesorbitan fatty acid esters, polyoxyethylenesorbitol fatty acid esters, glycerol fatty acid esters and polyoxyethylene fatty acid esters; amine type nonionic surfactants such as polyoxyethylenealkylamines and alkylalkanolamides; etc.
The above-mentioned nonionic surfactant may be any of aromatic compounds, linear compounds and branched compounds. From the environmental viewpoint, however, it is preferably a straight or branched compound having no alkyl phenol moiety in the structure thereof.

The above-mentioned aqueous fluoropolymer dispersion may have a nonionic surfactant content of 20 parts or less by mass, more preferably 15 parts or less by mass, per 100 parts by mass of the fluoropolymer.

The nonionic surfactant content mentioned above is the total content of the nonionic surfactants including the above-mentioned specific nonionic surfactant.
When another nonionic surfactant is added to the aqueous fluoropolymer dispersion, the specific nonionic surfactant preferably amounts to 40% by mass or less, more preferably 30% by mass or less, relative to the above-mentioned nonionic surfactant from the aqueous dispersion stability viewpoint and, from the viewpoint of suppressing foaming of the aqueous dispersion, it preferably amounts to 5% by mass or more, more preferably 10% by mass or more, of the above-mentioned nonionic surfactant.
The nonionic surfactant content (N), so referred to herein, is determined by weighing about 1 g (X g) of the sample in an aluminum cup with a diameter of 5 cm, heating the sample at 100° C. for 1 hour to give a heating residue (Y g), heating the heating residue (Y g) obtained at 300° C. for 1 hour to give a heating residue (Z g) and making a calculation according to the formula: N=[(Y−Z)/Z]×100(%). The amount of the specific nonionic surfactant among the nonionic surfactants can be calculated from the amount added on the occasion of preparing the aqueous fluoropolymer dispersion.

The above-mentioned anionic surfactant preferably comprises a fluorinated surfactant.

The above-mentioned fluorinated surfactant is not particularly restricted provided that it comprises a fluorinated compound and shows an emulsifying activity. The constituent fluorinated compound is preferably one having an average molecular weight of 1000 or less and, from the ease of removal viewpoint, one having an average molecular weight of 500 or less is more preferred and, further, one of 6 to 12 carbon atoms is preferred.
Preferred as the above-mentioned fluorinated surfactant are those comprising a fluorinated anionic compound such as a fluorinated carboxylic acid compound or a fluorinated sulfonic acid compound (hereinafter sometimes referred to as “fluorinated anionic surfactant”). More preferred are those comprising a fluorinated carboxylic acid compound or a salt thereof.
As the above-mentioned fluorinated anionic compound, there may be mentioned, for example, perfluorooctanoic acid and salts thereof (hereinafter “perfluorooctanoic acid and salts hereof” are sometimes collectively referred to as “PFOA”) and perfluorooctylsulfonic acid and salts thereof (hereinafter “perfluorooctylsulfonic acid and salts thereof” are sometimes collectively referred to as “PFOS”).
When the above-mentioned fluorinated anionic compound is in the form of a salt, the counter ion forming the salt is, for example, an alkali metal ion or NH₄⁺. As the alkali metal ion, there may be mentioned, for example Na⁺ and Ka⁺. Preferred as the counter ion is NH₄⁺, however. When the above-mentioned PFOA or PFOS is in the form of a salt, the salt is not particularly restricted but may be the ammonium salt, for instance.
The above-mentioned fluorinated surfactant may be the one added as an emulsifier (polymerization emulsifier) on the occasion of polymerization of the fluoropolymer in an aqueous medium.

In the aqueous fluoropolymer dispersion of the present invention, a fluorinated anionic surfactant concentration amounts to generally 500 ppm or less of the solid matter of fluoropolymer, preferably 200 ppm or less, more preferably 100 ppm or less of the above-mentioned solid matter and, when it contains PFOA, in particular, the concentration in question amounts to preferably 75 ppm or less of the solid matter of fluoropolymer, more preferably 50 ppm or less of that solid matter, still more preferably 25 ppm or less of that solid matter.

The aqueous fluoropolymer dispersion of the present invention is excellent in that even when the fluorinated anionic surfactant concentration is low, for example within the range mentioned above, the aqueous fluoropolymer dispersion can have a fluoropolymer concentration sufficiently high for practical use.

The fluorinated anionic surfactant content, so referred to herein, is determined by adding an equal volume of methanol to such aqueous dispersion, subjecting the mixture to Soxhlet extraction and subjecting the extract to high-performance liquid chromatography [HPLC] under the conditions to be mentioned later herein.

The aqueous fluoropolymer dispersion of the present invention can be prepared, for example, by (1) carrying out fluoropolymer polymerization and then (2) adding a specific nonionic surfactant to the dispersion of fluoropolymer as obtained in the above step (1).

The fluoropolymer polymerization (1) can be carried out in the conventional manner by suspension polymerization or emulsion polymerization, for instance.

The fluorinated monomer, nonfluorinated monomer, polymerization initiator, chain transfer agent and other additives to be used in the above-mentioned polymerization all may be appropriate ones known in the art and the above-mentioned fluorinated surfactant may be used according to need.
From the polymerization efficiency viewpoint, the above polymerization is preferably carried out in the presence of a fluorinated surfactant in an amount of 0.0001 to 10% by mass of the aqueous medium mentioned above. The amount of the fluorinated surfactant is preferably 0.001% by mass or higher, more preferably 1% by mass or higher, of the aqueous medium.

The step (2) mentioned above is to be carried out so that the aqueous fluoropolymer dispersion obtained may contain a specific nonionic surfactant at a level within the range mentioned above.

When the molecular weight of the compound constituting the specific nonionic surfactant is high and/or the above-mentioned total mass (g) of —RO— is high, the hydrophobicity of the specific nonionic surfactant generally becomes high and the solubility in water tends to decrease, as mentioned hereinabove. When the solubility of the specific nonionic surfactant in water is low, it is also possible to dissolve the surfactant in an organic solvent and add the solution to the aqueous fluoropolymer dispersion A.
As the organic solvent, there may be mentioned, for example, alcohols such as methanol, ethanol and isopropyl alcohol; ethers such as dimethyl ether, diethyl ether and tetrahydrofuran; etc.

The aqueous fluoropolymer dispersion of the present invention may be one obtained by passing through furthermore fluorinated surfactant content reducing step (3) in addition to the above-mentioned step (1) and step (2).

The step (3) may be carried out prior to the step (2) or after the step (2). After carrying out the step (2) and step (3), the step (2) may further be carried out.
From the viewpoint of reducing the loss of the specific nonionic surfactant added, the step (3) is preferably carried out prior to the step (2).

The fluorinated surfactant content reducing step (3) is not particularly restricted but preferably comprises at least one procedure selected from among phase separation, ion exchange resin treatment, membrane treatment, electrophoresis and evaporation, preferably at least one procedure selected from among phase separation, ion exchange resin treatment and membrane treatment.

The fluorinated surfactant content reducing step (3) may comprise one single run or two or more runs.

As the procedures in the fluorinated surfactant content reducing step (3), there may be mentioned, for example, the phase separation method described in International Publication WO 2004/050719, the ion exchange resin method described in Japanese Kohyo Publication 2002-532583, the membrane treatment method described in Japanese Kokai Publication Sho-55-120630, the electrophoretic method described in British Patent No. 642025 and the evaporation method described in Japanese Kohyo Publication 2003-531232.

The aqueous fluoropolymer dispersion of the present invention may also be one obtained by passing through a step (4) of adding an anionic surfactant (P) and/or a water-soluble polymer (Q) for viscosity adjustment and/or a step (5) of adding the above-mentioned nonionic surfactant, in addition to the above-mentioned step (1), step (2) and optional step (3). In preparing the aqueous fluoropolymer dispersion mentioned above, the step (4) and step (5) may be carried out at any stage after the step (1) and thus can be carried out simultaneously with the above-mentioned step (2). From the viewpoint of reducing the loss of the specific nonionic surfactant added, however, the step (4) and/or step (5) is preferably carried out after the above-mentioned step (3).

The anionic surfactant (P) mentioned above is generally selected from the group consisting of (a) sulfosuccinic acid alkyl esters or salts thereof or sulfosuccinic acid fluoroalkyl esters or salts thereof, (b) fluorinated anionic surfactants other than those used in the above-mentioned step (1), having a molecular weight lower than 1000, (c) nonfluorinated anionic surfactants having an acid group and showing a pKa value lower than 4 and (d) the fluorinated anionic surfactant to be used in the above-mentioned step (1), having a molecular weight lower than 1000.

The above-mentioned sulfosuccinic acid alkyl esters or salts thereof and/or sulfosuccinic acid fluoroalkyl esters or salts thereof (a) are preferably diesters although those may also be monoesters.

The fluorinated surfactant (b) preferably has 4 to 7 carbon atoms, more preferably 5 to 7 carbon atoms.
As the fluorinated anionic surfactant (b), preferred are fluoroalkylcarboxylic acids or salts thereof and fluoroalkylsulfonic acids or salts thereof. More preferred are perfluorocarboxylic acids or salts thereof and perfluoroalkylsulfonic acids or salts thereof.
Preferred as the surfactant (c) are anionic hydrocarbon-based surfactants having a hydrocarbon as the main chain.
As the hydrocarbon, there may be mentioned, for example, ones having a saturated or unsaturated aliphatic chain of 6 to 40 carbon atoms, preferably 8 to 20 carbon atoms. The saturated or unsaturated aliphatic chain may be either straight or branched and may be one having a cyclic structure. The above-mentioned hydrocarbon may also be one of aromatic nature or an aromatic group having one. The hydrocarbon may further be one having at least one such hetero atom as an oxygen, nitrogen or sulfur atom.
As the surfactant (c), there may be mentioned alkylsulfonates, alkyl sulfates and alkylaryl sulfates and salts thereof; aliphatic (carboxylic) acids and salts thereof; phosphoric acid alkyl esters and phosphoric acid alkylaryl esters or salts thereof. Among them, ones selected from the group consisting of sulfonic acids and carboxylic acids, inclusive of salts thereof, are preferred, and aliphatic carboxylic acids or salts thereof are preferred.
When it is in the form of a salt, the above-mentioned anionic surfactant (P) can include the partly or wholly dissociated form.
As the salt, there may be mentioned the same ones as enumerated hereinabove referring to the fluorinated surfactant.

The addition level of anionic surfactant (P) may amount to generally 5 to 5000 ppm, preferably 5 to 2500 ppm, more preferably 5 to 1000 ppm, of the mass of the fluoropolymer and, from the addition level reduction viewpoint, it may amount to generally 5 to 500 ppm, preferably 200 ppm or less, of the mass of the fluoropolymer. From the mechanical strength maintenance viewpoint, among others, the above-mentioned addition level may amount to preferably 10 ppm or more of the mass of the fluoropolymer provided that it is within the range mentioned above.

When the above-mentioned (d) is added as the anionic surfactant (P) in the practice of the present invention, it is necessary that the surfactant (d) be added so that the total content of (d) may not exceed 500 ppm of the solid matter of fluoropolymer.

The water-soluble polymer (Q) mentioned above is a compound whose solubility in water is not lower than 0.1 mg/100 ml and which has a molecular weight of not lower than 10000 and not higher than 20000000.

The solubility in water is preferably not lower than 1 mg/100 ml.
The water-soluble polymer (Q) preferably has a molecular weight of not higher than 5000000, more preferably not higher than 2000000, provided that the molecular weight is within the range mentioned above.
The water-soluble polymer (Q) preferably comprises at least one species selected, for example, from the group consisting of polyacrylic acid, polyacrylic acid derivatives, polyvinylpyrrolidone, poly(vinyl methyl ether), poly(vinyl alcohol) and polyethylene oxide.
In the practice of the present invention, the water-soluble polymer (Q) is added preferably in an amount of 0.00001 to 5 parts by mass per 100 parts by mass of the fluoropolymer. A more preferred lower limit to the addition level of the water-soluble polymer (Q) is 0.0001 part by mass and a more preferred upper limit thereto is 2.1 parts by mass, per 100 parts by mass of the fluoropolymer.

In the above-mentioned step (5), the nonionic surfactant may be added within the above-mentioned preferred range so that the specific nonionic surfactant-due effects may not be affected.

The aqueous fluoropolymer dispersion of the present invention is very low in fluorinated surfactant content and, therefore, even when it is processed into films, coating films or the like, no discoloration will occur. Furthermore, the aqueous fluoropolymer dispersion, which contains the above-mentioned specific nonionic surfactant, is low in viscosity and is excellent in mechanical stability, temperature stability, storage stability, applicability and penetration in impregnation, among others, in spite of its high fluoropolymer concentration. It is high in crack limit film thickness, hardly foams and is excellent in the property of clearing foaming on the occasion of foaming at the worst.

The aqueous fluoropolymer dispersion of the present invention, either as such or after addition of one or more of various additives, can be processed into coatings, films such as cast films, and impregnated articles (the so-called impregnations), among others.

The above-mentioned aqueous fluoropolymer dispersion can be processed, for example, into coatings of cooking utensils such as oven linings or ice-cube trays, electric wires, pipes, ship bottoms, high-frequency printed circuit boards, conveyer belts and iron soleplates; impregnations derived from fibrous substrates, woven or nonwoven fabrics and like impregnation targets; and so forth. The fibrous substrates are not particularly restricted but include, among others, glass fibers, carbon fibers, aramid fibers (Kevlar (registered trademark) fibers etc.) and so forth.
The above-mentioned processing of the aqueous fluoropolymer dispersion can be carried out in the conventional manner. The coated articles and films obtained from the above-mentioned aqueous fluoropolymer dispersion as well as the impregnated articles which is a product impregnated with the above-mentioned aqueous fluoropolymer dispersion also constitute an aspect of the present invention.

### EFFECTS OF THE INVENTION

The aqueous fluoropolymer dispersion of the present invention, which has the constitution described hereinabove, can be prepared as an aqueous fluoropolymer dispersion showing an adequate level of viscosity, mechanical stability and suppressed foamability.

### BEST MODES FOR CARRYING OUT THE INVENTION

The following experiment examples and test examples illustrate the present invention in further detail. These experiment examples and test examples are, however, by no means limitative of the scope of the present invention.

In the experiment examples and test examples, “part(s)” indicates “part(s) by mass”, unless otherwise specified.

The measurements made in each experiment example were carried out by the methods described below.

(1) Average Particle Diameter

A working curve was constructed which shows the relation between the transmittance of incident light rays having a wavelength of 550 nm per unit length of the aqueous fluoropolymer dispersion and the average particle diameter determined by particle diameter measurements in a certain specific direction on a transmission electron photomicrogaph, and the average particle diameter of a sample was determined, using the working curve, from the transmittance as measured in the above manner.

(2) Fluoropolymer Concentration (P)

The concentration was determined by weighing about 1 g (X g) of the sample in an aluminum cup with a diameter of 5 cm, drying the sample at 100° C. for 1 hour and then further drying at 300° C. for 1 hour to give a heating residue (Z) and making a calculation as follows: P=Z/X×100(%).

(3) Fluorinated Surfactant Concentration

The concentration was determined by adding an equal amount of methanol to the aqueous dispersion obtained, subjecting the mixture to Soxhlet extraction and subjecting the extract obtained to high-performance liquid chromatography [HPLC] under the conditions given below. In calculating the fluorinated surfactant concentration, use was made of a working curve constructed by carrying HPLC measurements for known fluorinated surfactant concentrations under the same conditions as for the above-mentioned eluate.

(4) Nonionic Surfactant Content (N)

About 1 g (X g) of the sample was weighed in an aluminum cup with a diameter of 5 cm and heated at 100° C. for 1 hour to give a heating residue (Y g), the heating residue (Y g) obtained was further heated at 300° C. for 1 hour to give a heating residue (Z g), and the content was calculated according to the formula N=[(Y−Z)/Z]×100(%).
The content of the specific nonionic surfactant out of the above content was calculated from the amount thereof added on the occasion of preparing the aqueous fluoropolymer dispersion.

(5) Viscosity

Viscosity measurements were carried out at 25° C. or 35° C. according to JIS K 6893 using a type B rotational viscometer (product of Tokyo Keiki). The measurement results were evaluated on the following criteria.
⊚: The viscosities at both 25° C. and 35° C. are lower than 40 mPa·s;
◯: The viscosities at both 25° C. and 35° C. are lower than 40 to 50 mPa·s;
Δ: The viscosities at both 25° C. and 35° C. are lower than 50 to 70 mPa·s;
X: The viscosities at both 25° C. and 35° C. are not lower than 70 mPa·s.

(6) Mechanical Stability

A 100-ml portion of each aqueous fluoropolymer dispersion was maintained at 35° C. and circulated using a diaphragm pump connected with a polyvinyl chloride) tube with an inside diameter of 8 mm and an outside diameter of 11 mm at a rate of 1500 ml/minute for 20 minutes and then filtered through a 200-mesh SUS stainless steel screen. The oversize fraction was weighed, and the proportion (% by mass) thereof to the fluororesin in the aqueous fluoropolymer dispersion used was determined. The measurement results were evaluated on the following criteria.
⊚: Lower than 1% by mass;
◯: Not lower than 1% by mass but lower than 2% by mass;
Δ: 3% by mass or higher.

(7) Foaming Suppression

For evaluation, the Ross Miles test was carried out according to JIS K 3362.
⊚: Lower than 150 mm in foam height;
◯: Not lower than 150 mm but lower than 180 mm in foam height;
Δ: Not lower than 180 mm in foam height.

### Production Example 1

A nonionic surfactant (product name: Noigen TDS-80, product of Daiichi Kogyo Seiyaku) and water were added to a PTFE dispersion 1 (average particle diameter 250 nm, PTFE concentration 31%, PFOA content: 1500 ppm of PTFE) and the pH was adjusted to 9.5 with aqueous ammonia to give a dispersion having a fluoropolymer concentration [PC] of 25% and a nonionic surfactant concentration [NC] of 25 parts by mass per 100 parts by mass of PTFE. The dispersion was maintained at 80° C. for 3 hours for separation into a supernatant phase 1 and a concentrated phase 1.
The above-mentioned concentrated phase 1 had a PC of 37% and an NC of 2.4 parts by mass per 100 parts by mass of PTFE, and a PFOA content corresponding to 190 ppm of PTFE.
Further, the above-mentioned nonionic surfactant and water added to the concentrated phase 1 to thereby adjust the PC to 25% and the NC to 15 parts by mass per 100 parts by mass of PTFE, the resulting dispersion was maintained at 60° C. for 5 hours, and a concentrated phase 2 (PTFE dispersion 2) having a PC of 69%, an NC of 3.8 parts by mass per 100 parts by mass of PTFE, and a PFOA content corresponding to 20 ppm of PTFE was recovered.

### Example 1

Noigen TDS-80, a specific nonionic surfactant (product name: Pluronic PE6800, product of BASF; proportion of EO: 80% by mass) and water were added to the PTFE dispersion 2 obtained in Production Example 1 to thereby adjust the PO to 60%, the Noigen TDS-80 content to 5 parts by mass per 100 parts by mass of PTFE, and the specific nonionic surfactant concentration to 1 part by mass per 100 parts by mass of PTFE. An aqueous PTFE dispersion was thus obtained.
The above-mentioned aqueous PTFE dispersion was measured for viscosity, mechanical stability and foaming suppression.

### Examples 2 to 6

Aqueous PTFE dispersions were prepared in the same manner as in Example 1 except that a water-soluble polymer and an anionic surfactant were further added as respectively specified in Table 1. The dispersions obtained were measured for viscosity, mechanical stability and foaming suppression.

### Comparative Example 1

An aqueous PTFE dispersion was prepared in the same manner as in Example 1 except that Pluronic PE6400 (product name, product of BASF; average molecular weight 2900, proportion of EO: 40% by mass) was used in lieu of Pluronic PE6800 as the specific nonionic surfactant. The aqueous PTFE dispersion was measured for viscosity, mechanical stability and foaming suppression.

The data for the respective aqueous PTFE dispersions obtained in Examples 1 to 6 and Comparative Example 1 are shown in Table 1. In Table 1 and in Table 2 which will appear later herein, TDS80 stands for Noigen TDS-80, PVP for PITZCOL, PEG 20000 for polyethylene glycol, OTP for C₈H₁₇OCOCH(SO₃Na)CH₂COOC₈H₁₇, and SLS for sodium lauryl sulfate. The contents of the nonionic surfactant and water-soluble polymer are given in terms of amount (part (s) by mass) per 100 parts by mass of PTFE, and the anionic surfactant contents in terms of proportion (ppm) relative to the amount of PTFE.

TABLE 1

| | | Nonionic surfactant | | | | | | | | | | | |
|---|---|---|---|---|---|---|---|---|---|---|---|---|---|
| | | | Specific | | | | | Viscosity | | | | | |
| | PC | | nonionic | Water-soluble | | Anionic | | | 25° C. | 35° C. | Mechanical | | Foaming |
| | (%) | TDS80 | surfactant | polymer | | surfactant | | Evaluation | (mPa · s) | (mPa · s) | stability (%) | | suppression (%) |
| Exmaple 1 | 60 | 5 | 1 | None | | None | | ◯ | 45 | 35 | ◯ | 1.5 | ⊚ |
| Exmaple 2 | 60 | 5 | 1 | PVP | 0.1 | None | | ⊚ | 30 | 27 | ◯ | 1.4 | ⊚ |
| Exmaple 3 | 60 | 5 | 1 | PVP | 0.1 | OTP | 300 | ⊚ | 27 | 23 | ⊚ | 0.8 | ⊚ |
| Exmaple 4 | 60 | 5 | 1 | PEG20000 | 1 | OTP | 300 | ⊚ | 32 | 28 | ◯ | 1.2 | ⊚ |
| Exmaple 5 | 60 | 5 | 1 | PVP | 0.1 | SLS | 500 | ⊚ | 26 | 22 | ⊚ | 0.9 | ⊚ |
| Exmaple 6 | 60 | 5 | 1 | PEG20000 | 1 | SLS | 500 | ⊚ | 33 | 29 | ⊚ | 1 | ⊚ |

| | | | | | | | | | | | |
|---|---|---|---|---|---|---|---|---|---|---|---|
| Comparative | 60 | 5 | 1 | None | None | ◯ | 48 | 40 | Δ | 2.5 | ⊚ |
| Example 1 | | | | | | | | | | | |

From the results shown, it was revealed that the aqueous PTFE dispersions of the examples are all highly effective, in particular, in preventing the viscosity from increasing with the increase in temperature and in suppressing foaming.

### Production Example 2

To a PTFE dispersion 3 (average particle diameter 220 nm, PTFE 32%, PFOA content: 1800 ppm of PTFE) was added 5 parts by mass per 100 parts by mass of PTFE of a nonionic surfactant (product name: Noigen TDS-80, product of Daiichi Kogyo Seiyaku), followed by further addition of water to thereby adjust the PC to 27%. The resulting dispersion was passed through a column (diameter 20 mm) packed with 25 ml of an anion exchange resin (product name: Amberlite IRA402, product of Rohm and Haas) and maintained at 50° C. at a space velocity (SV) of 4. The thus-obtained dispersion had a PC of 27%, an NC of 5 parts by mass per 100 parts by mass of PTFE, and a PFOA content corresponding to 18 ppm of PTFE.
To the above dispersion was added 10 parts by mass per 100 parts by mass of PTFE of the above-mentioned nonionic surfactant, followed by further addition of water to thereby adjust the PC to 25%. The resulting dispersion was heated at 70° C. for 3 hours for separation into a supernatant phase and a concentrated phase.
The concentrated phase (PTFE dispersion 4) had a PC of 63% and an NC of 2.5 parts by mass per 100 parts by mass of PTFE; the PFOA content was below the detection limit.

### Example 7

To the PTFE dispersion 4 obtained in Production Example 2 were added 3.5 parts by mass per 100 parts by mass of PTFE of Noigen TDS-80 and 1.5 parts by mass per 100 parts by mass of PTFE of a specific nonionic surfactant (product name: Pluronic PE6800, product of BASF), followed by further addition of PVP and OTP. The thus-obtained dispersion was measured for viscosity, mechanical stability and foaming suppression.

### Comparative Example 2

An aqueous PTFE dispersion was prepared in the same manner as in Example 1 except that no specific nonionic surfactant was added and the amount of Noigen TDS-80 was varied. The dispersion was measured for viscosity, mechanical stability and foaming suppression.

The data for the aqueous PTFE dispersions respectively obtained in Example 7 and Comparative Example 2 are shown in Table 2. The contents of the nonionic surfactant and water-soluble polymer are given in terms of amount (part(s) by mass) per 100 parts by mass of PTFE, and the anionic surfactant contents in terms of proportion (ppm) relative to the amount of PTFE.

TABLE 2

| | | Nonionic surfactant | | | | | | | | | | | |
|---|---|---|---|---|---|---|---|---|---|---|---|---|---|
| | | | Specific | Water- | | | | Viscosity | | | | | |
| | PC | | nonionic | soluble | | Anionic | | | 25° C. | 35° C. | Mechanical | | Foaming |
| | (%) | TDS80 | surfactant | polymer | | surfactant | | Evaluation | (mPa · s) | (mPa · s) | stability (%) | | suppression (%) |
| Exmaple 7 | 60 | 3.5 | 1.5 | PVP | 0.1 | OTP | 300 | ⊚ | 35 | 28 | ⊚ | 0.9 | ⊚ |
| Comparative | 60 | 5 | 0 | PVP | 0.1 | OTP | 300 | X | 80 | 100 | Δ | 2.3 | Δ |
| Example 2 | | | | | | | | | | | | | |

The aqueous PTFE dispersion obtained in Example 7 was low in viscosity and excellent in mechanical stability and foaming suppression, whereas the aqueous PTFE dispersion obtained in Comparative Example 2 was high in viscosity and showed a marked increase in viscosity with the increase in temperature, was somewhat inferior in mechanical stability, and showed foaming.

### INDUSTRIAL APPLICABILITY

The aqueous fluoropolymer dispersion, which has the constitution described hereinabove, can be prepared as an aqueous fluoropolymer dispersion showing an adequate level of viscosity, mechanical stability and suppressed foamability.

1. An aqueous fluoropolymer dispersion comprising a particle of fluoropolymer as dispersed in an aqueous medium in the presence of a specific nonionic surfactant, wherein said specific nonionic surfactant comprises a compound having an average total hydrophilic group content of 45 to 90% by mass, each hydrocarbon group in said compound constituting the specific nonionic surfactant is only a hydrocarbon group of 1 to 5 consecutively neighboring carbon atoms, and a fluorinated surfactant in said aqueous fluoropolymer dispersion amounts to 500 ppm or less of the solid matter of the fluoropolymer.

2. The aqueous fluoropolymer dispersion according to claim 1, wherein the compound constituting the specific nonionic surfactant has a repeating structure of a unit —RO— and/or —OR—, wherein R represents a hydrocarbon group of 3 to 5 carbon atoms and a plurality of R occurring in the repeating structure are the same or different one another.

3. The aqueous fluoropolymer dispersion according to claim 2, wherein the repeating structure of the unit —RO— and/or —OR—, R being as defined above, comprises a unit —C₃H₆O— and/or —OC₃H₆— and the total mass of said unit —C₃H₆O— and/or —OC₃H₆— is 500 to 5000 g per mole of the compound constituting the specific nonionic surfactant.

4. An aqueous fluoropolymer dispersion comprising a particle of fluoropolymer as dispersed in an aqueous medium in the presence of a specific nonionic surfactant, wherein said specific nonionic surfactant comprises a compound having a unit —C₃H₆O— and/or —OC₃H₆— in the total mass of 500 to 5000 g per mole of a compound constituting the specific nonionic surfactant, each hydrocarbon group in said compound constituting the specific nonionic surfactant is only a hydrocarbon group of 1 to 5 consecutively neighboring carbon atoms, and a fluorinated surfactant in said aqueous fluoropolymer dispersion amounts to 500 ppm or less of the solid matter of fluoropolymer.

5. The aqueous fluoropolymer dispersion according to claim 4, wherein the hydrophilic group in the compound constituting the specific nonionic surfactant comprises a repeating structure of a unit —C₂H₄O— and/or —OC₂H₄—.

6. The aqueous fluoropolymer dispersion according to claim 5, wherein the hydrophilic group in the compound constituting the specific nonionic surfactant comprises the repeating structure of the unit —C₂H₄O— and/or —OC₂H₄— and the average total content of the unit —C₂H₄O— and/or —OC₂H₄— in said specific nonionic surfactant is 45 to 90% by mass.

7. The aqueous fluoropolymer dispersion according to claim 6, wherein the average total content of the unit —C₂H₄O— and/or —OC₂H₄— is 45 to 90% by mass of the compound constituting the specific nonionic surfactant.

8. The aqueous fluoropolymer dispersion according to claim 1, wherein the compound constituting the specific nonionic surfactant is an ethylene oxide-propylene oxide copolymer.

9. The aqueous fluoropolymer dispersion according to claim 8, wherein the ethylene oxide-propylene oxide copolymer is an ethylene oxide-propylene oxide block copolymer.

10. The aqueous fluoropolymer dispersion according to claim 1, wherein the compound constituting the specific nonionic surfactant has an average molecular weight lower than 15000.

11. The aqueous fluoropolymer dispersion according to claim 1, wherein the specific nonionic surfactant has a cloud point of 20 to 90° C.

12. The aqueous fluoropolymer dispersion according to claim 1, wherein the specific nonionic surfactant amounts to 40% or less by mass of the nonionic surfactants occurring in the aqueous fluoropolymer dispersion.

13. The aqueous fluoropolymer dispersion according to claim 1 which has passed through a fluorinated surfactant content reducing step.

14. The aqueous fluoropolymer dispersion according to claim 13, wherein the fluorinated surfactant content reducing step comprises at least one procedure selected from among phase separation, ion exchange resin treatment, membrane treatment, electrophoresis and evaporation.

15. The aqueous fluoropolymer dispersion according to claim 1, wherein the fluorinated surfactant concentration amounts to 100 ppm or less of the solid matter of fluoropolymer.

16. The aqueous fluoropolymer dispersion according to claim 1, wherein the fluoropolymer comprises polytetrafluoroethylene and/or modified polytetrafluoroethylene.

17. A coated article obtained from the aqueous fluoropolymer dispersion according to claim 1.

18. A film obtained from the aqueous fluoropolymer dispersion according to claim 1.

19. An impregnated article which is a product impregnated with the aqueous fluoropolymer dispersion according to claim 1.
